(19) United States
(12) Patent Application Publication
(10) Pub. No.: US 2015/0112853 A1
(43) Pub. Date: Apr. 23, 2015

(54) ONLINE LOAN APPLICATION USING IMAGE CAPTURE AT A CLIENT DEVICE

(71) Applicant: WONGA TECHNOLOGY LIMITED, Dublin (IE)

(72) Inventors: DANIEL HEGARTY, London (GB); Warren Blumenow, London (GB); Nikola Sivacki, London (GB); Zizhou Liu, London (GB); Javier de Vega Ruiz, Dublin (IE)

(73) Assignee: WONGA TECHNOLOGY LIMITED, Dublin (IE)

(21) Appl. No.: 14/057,484

(22) Filed: Oct. 18, 2013

(51) Int. Cl. G06Q 40/02

(52) U.S. Cl. CPC G06Q 40/025
USPC 705/38

(57) ABSTRACT

A user device, for example a smart phone, is used to apply for an online loan. The user device includes a camera which allows the user to capture an image of a document in the possession of the user. The image is transmitted to a remote computer system which carries out an automated loan decision making process to determine whether to provide an online loan to the user as a function of, inter alia, the image of the document. The automated loan decision making process can use the image to determine information about the user of the device who is requesting an online loan. The user device determines when to capture an image of the document when it is properly positioned within the frame of the camera and/or as a function of when it is properly focused in the frame of the camera.

### BACKGROUND OF THE INVENTION

This invention relates to methods and systems for applying for an online loan and also capturing of images of documents such as cards and the like using mobile devices. In particular, embodiments of the invention relate to capturing of images for optical character recognition of data on a card using a mobile device such as a smart phone.

Optical character recognition techniques are known for the automated reading of characters. For example, scanners for the automated reading of text on A4 pages and for scanning text on business cards and the like are known. However, such devices and techniques typically operate in controlled lighting conditions and capture plain, non-reflective surfaces.

### SUMMARY OF THE INVENTION

We have appreciated the need for improved methods, systems and devices for applying for online loans. We have also appreciated the need to improve capturing and processing images of documents such as cards and other regular shaped items bearing alphanumeric data. In particular, we have appreciated the need for capturing images of personal cards such as debit/credit cards, ID cards, cheques, driving licences and the like for very rapid input of data from an image of the object using a mobile device. Using image capture can speed up and simplify the capture of information entry and can also be used as a mechanism to detect fraud as part of fraud detection techniques.

Various attempts have also been made to automatically capture information from more challenging image surfaces such as credit card sized cards using devices such as smart phones. However, we have appreciated problems in capturing images from surfaces of such cards due to factors such as the variety of surface pattern arrangements and reflectivity of card surfaces.

In broad terms, the invention provides systems and methods for online loan applications in which an image of a document is captured as part of the loan application process.

Among the features of the invention are a new approach to detecting the edge of a card in an image, a new focus detection process and a new card framing process.

### BRIEF DESCRIPTION OF THE DRAWINGS

The invention will now be described in more detail by way of example with reference to the drawings, in which:

FIG. 1: is a flow diagram of an online loan application process embodying the invention;

FIG. 2: is a graphical representation of an image capture using a smart phone;

FIG. 3: is a functional diagram of the key components of a system embodying the invention;

FIG. 4: shows the framing of a card image;

FIG. 5: is a flow diagram showing the main process for capturing a card image;

FIG. 6: shows the capturing of an image of card;

FIG. 7: shows the card image of FIG. 6 after filtering using a known filter;

FIG. 8: shows the card image of FIG. 6 after filtering and channel processing according to an embodiment of the invention;

FIG. 9a: shows a focus value against a frame count value for a series of images;

FIG. 9b: shows a series of images;

FIG. 10: shows a focus selection using regions of interest;

FIG. 11: shows a sliding window algorithm;

FIG. 12: shows a first step of a card framing process;

FIG. 13: shows a second step of a card framing process;

FIG. 14: shows a third step of a card framing process;

FIG. 15: shows a final image resulting from the card framing process; and

FIG. 16: shows an image uploading arrangement.

### DETAILED DESCRIPTION OF THE PREFERRED EMBODIMENTS

The invention may be embodied in methods of operating client devices, methods of using a system involving a client device, client devices, modules within client devices and computer instructions for controlling operation of client devices. Client devices include, for example, personal computers, smart phones, tablet devices and other devices useable to access remote services. Client devices therefore include, but are not limited to, devices such as (a) smartphones with all functionality built into a single device and operating largely through an app on the smartphone, tablets, wearable devices or other portable client device; and (b) a PC which uses a digital camera (whether built-in (as in the case of a notebook/netbook/laptop), attached to the PC (e.g. via a USB webcam), or remote (e.g. on a separate smartphone)). Any and all such devices may be used.

The invention may be embodied in a method of providing an online loan. An online loan application is one conducted remotely to an online provision service using any wired or wireless connection such as the Internet and using either a web browser or client application to submit the online loan application request. The decision as to whether to provide a loan to the user is taken at the online loan service. In prior systems, an online loan application requires manual intervention at the loan provider. In preferred embodiments of the present invention, the online loan system is preferably fully automated in the sense that a computerized decision is made as to whether to provide a loan based on information supplied by the user and taken from other sources, without human intervention.

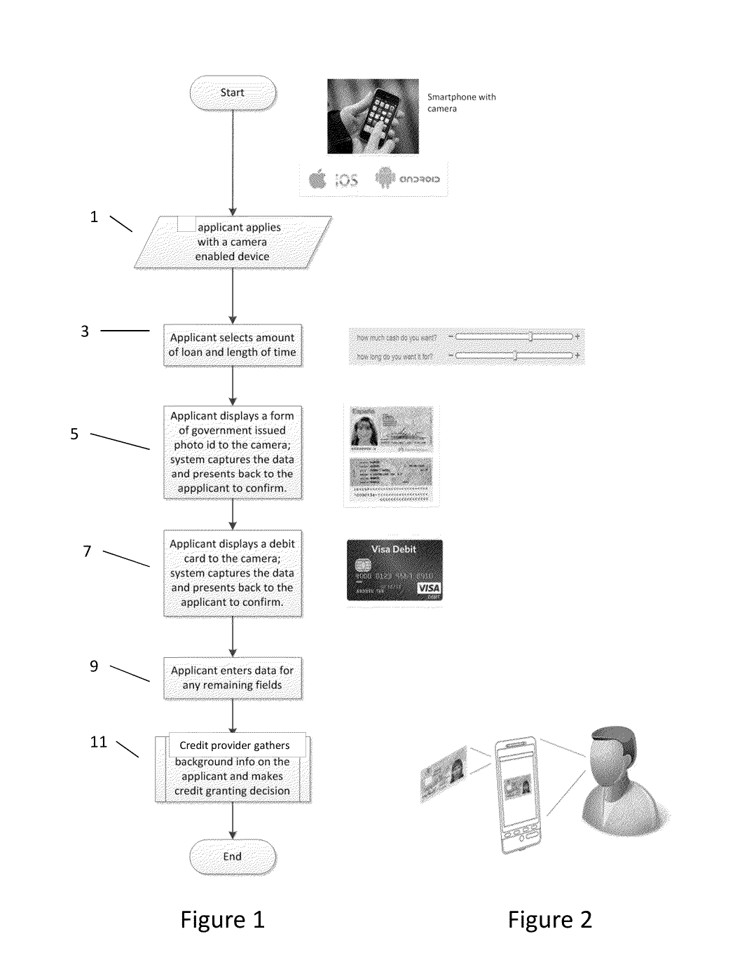

An online loan application process embodying the invention is shown in the flow diagram of FIG. 1.

A user wishing to apply for an online loan using the service first uses their smart user device such as a smart phone, tablet or other personal user device incorporating a camera (i.e., an imaging system) to download an application or plug-in which comprises program code executable on the client device. The downloadable program has a number of functional components described later.

Once the user has installed the application, the user may apply for an online loan using the application as shown at step 1 of FIG. 1. The user selects an amount of time for the loan and length of time for the loan as shown at step 3. Information regarding the applicant, including the applicant name, the selected amount of time and selected amount for the loan are transmitted to an online loan system (typically comprising one or more programmed processors) so that processing of the loan application can begin.

The application then asks the user to capture an image of a document using the camera of their user device. The precise document will vary by jurisdiction, but will typically be a government issued photo ID, such as a driving licence, passport or other ID card. Typically, a card is a type of document that is of a size to fit in a standard wallet, namely “credit card” sized. The user then uses the camera of their user device to capture an image of the ID card as shown schematically in FIG. 2 at step 5, and the user device presents the image back to the user to confirm that it is an accurate representation. The capturing step involves various techniques to ensure accuracy of position, focus and framing as described later.

At this stage, the online loan system may have sufficient information to make a decision as to whether to provide a loan. The decision as to whether to provide a loan may include, inter alia, a decision on the amount, length of time and whether or not to provide a loan at all to the user. The decision may include factors such as whether the user is a new user or a repeat user of the system. In particular, the decision uses information extracted from the image of the card captured by the camera of the user device and provided at step 5.

The application may optionally request the user to capture one or more further images, such as an image of a debit card at step 7 which again uses various framing focusing and perspective correction techniques discussed later. In some arrangements, this additional capture step may be uses as part of the decision process, for example the online loan system may require a user to present a valid debit card in order for the loan decision to be granted.

The applicant may then enter any further data required by the online loan system as presented by the application at step 9 and this is transmitted to the online loan system which gathers any additional information needed at step 11 and then makes a credit granting decision.

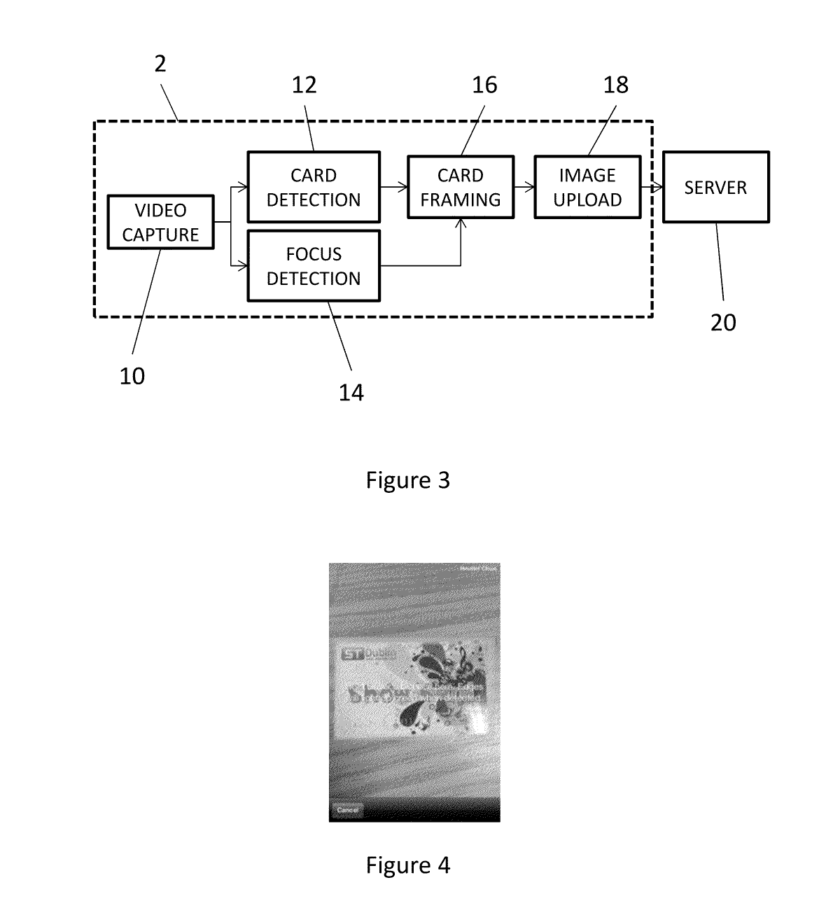

The above describes an overall processing system for applying for an online loan. A client device and a system will now be described with reference to FIG. 3.

A client device embodying the invention is arranged to capture an image of a document such as a card. Such a card may be a credit card, debit card, store card, driving licence, ID card or any of a number of credit card sized items on which text and other details are printed. For ease of description, such cards will be simply referred to hereafter as “cards”, and include printed, embossed and cards with or without a background image. Other objects with which the embodying device and methods may be used include cheques, printed forms, passports and other such documents. In general, the embodying device and processes are arranged for capture of images of rectangular documents, in particular cards which are one type of document.

A system embodying the invention is shown in FIG. 3. The system shown in FIG. 3 comprises a mobile client device such as a smart phone, tablet device or the like 2 and a server system 20 to which the client device connects via any known wired or wireless network such as the Internet. The client device 2 comprises a processor, memory, battery source, screen, camera and input devices such as keyboard or touch screen. Such hardware items are known and will not be described further. The device is arranged to have a number of separate functional modules, each of which may be operable under the command of executable code. As such, the functional components may be considered either hardware modules or software components running on one or more processors.

A video capture module or camera 10 is arranged to produce a video stream of images comprising a sequence of frames. The video capture module 10 will therefore include imaging optics, sensors, executable code and memory for producing a video stream. The video capture module provides the sequence of frames to a card detection module 12 and a focus detection module 14. The camera 10 may also be arranged to capture a single image frame, rather than a sequence of frames. A frame or still frame may therefore be considered to be an image frame captured individually or one frame from a sequence of video frames.

The card detection module 12 provides the functionality for determining the edges of a card and then determining if the card is properly positioned within the video frame. This module provides an edge detection algorithm and a Hough transform based card detection algorithm. The latter uses the edge images, which are generated by the former, and determines whether the card is properly positioned in each frame of the video stream. The focus detection module 14 is arranged to determine which frames of a sequence of frames are in focus. One reason for providing such focus detection is that many smart phones do not allow applications to control the actual focus of the camera system, and so the card detection arrangement is reliant upon the camera autofocus. This module preferably includes an adaptive threshold algorithm, which has been developed to determine the focus status of the card in each frame of the video stream. The adaptive threshold algorithm uses focus values calculated by one of a number of focus metrics discussed later. A card framing module 16 is arranged to produce a final properly framed image of a card. This module combines a card detection process and card framing algorithm and produces a properly framed card image from a high-resolution still image. An image upload module 18 is arranged to upload the card image to the server 20.

The overall operation of the system shown in FIG. 3 will now be described before discussing each of the functional modules in turn.

A front end client application of the client device 2, comprising the modules described, produces a live video stream of the user's card using the user device's camera while the user positions the card in a specific region indicated by the application (referred to as the “card alignment box” shown in FIG. 4). The functional modules then operate as quickly as possible to produce a properly framed, in focus image of the card. The main modules operate as follows. The card detection module 12 analyses live video frames to determine whether the card is properly positioned. The focus detection module 14 processes live video frames and decides whether the camera is properly focused on the card. Once the card is properly positioned and the card is in focus, the application causes the user device to automatically take a new still image. This still image, along with card position metrics generated by card detection algorithm, is sent to the card framing module 16. The card framing module 16 receives the still image and produces a properly framed card image (i.e., one in which the background details have been removed) for upload by an image upload module 18. The properly framed card image is then uploaded to a backend server 20 for Optical Character Recognition (OCR). Once OCR has been completed, the OCR result is placed on the backend server ready for the client application of the user device to use. The high resolution images captured are also uploaded to remote storage of the server in the background via a queuing mechanism, shown here as image upload module, designed to minimize the effect on the user experience of the application.

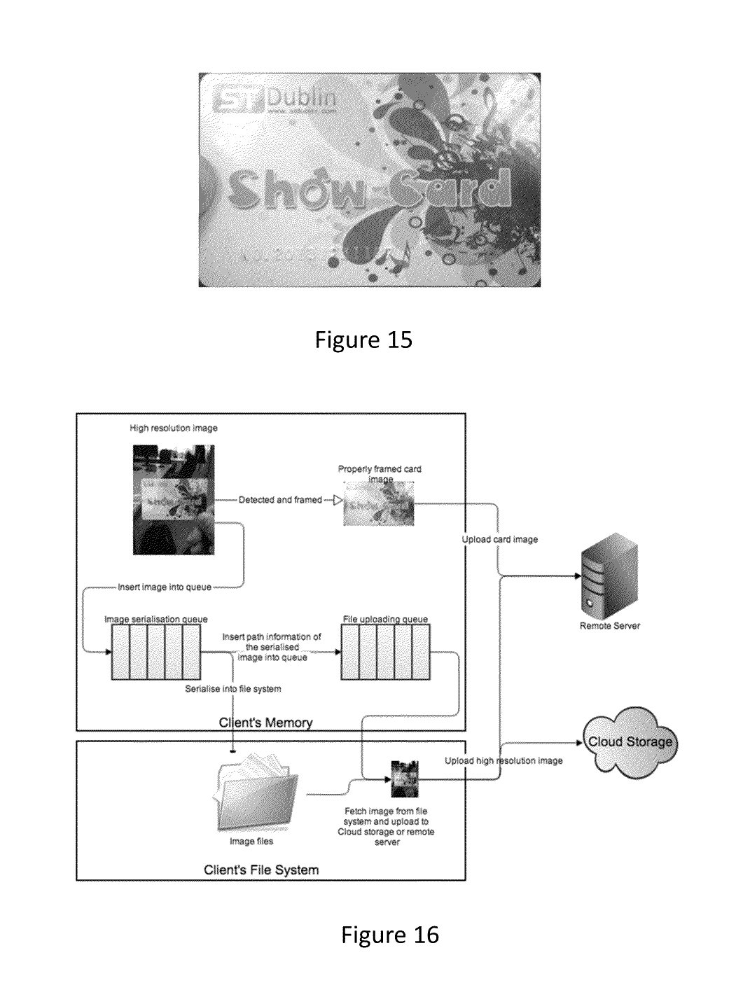

The output of the process is a properly framed card image in the sense that all background details are removed from the original image, only the card region is extracted, and the final card image has no perspective distortion, as shown in FIG. 15 and described later.

The modules will now be described in turn. The modules may be provided by dedicated hardware, but the preferred embodiment is for each module to be provided as program code executable by one or more processors of a client device.

### Card Detection Process

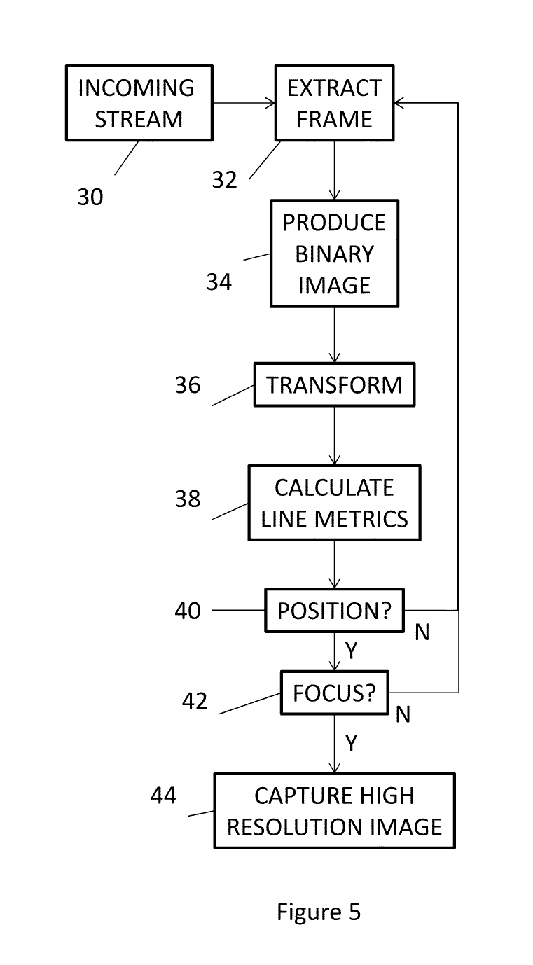

A card detection process embodying the invention will now be described with reference to FIGS. 5 to 8. The purpose of the card detection process is to assist a user to position the card correctly, and decide whether the card is properly aligned within the frame and in focus. The output is a captured high-resolution image and card position metrics.

We have appreciated a number of problems involved in detecting the card. First, the diversity of cards means that process needs to work well across a high diversity of card surfaces. In addition, the likely cluttered background during card detection means that the process should be able to detect a card placed against a cluttered background. The process should also perform all processing in real-time to ensure a responsive user experience and provide a sense of control when the user uses the application to capture a card. The user should be able to use the system easily such as choosing to place the card on a surface or hold the card with their fingers while capturing. The process should also be able to detect cards in cases when one or more of the card's corners are occluded or the card's edges are partially occluded, such as by the user's finger.

In order to address the various problems noted, the card detection module 12 preferably operates a process as shown in FIG. 5. The process shown in FIG. 5 operates on an incoming video stream which is analysed. For each incoming video frame the process operates the following steps:

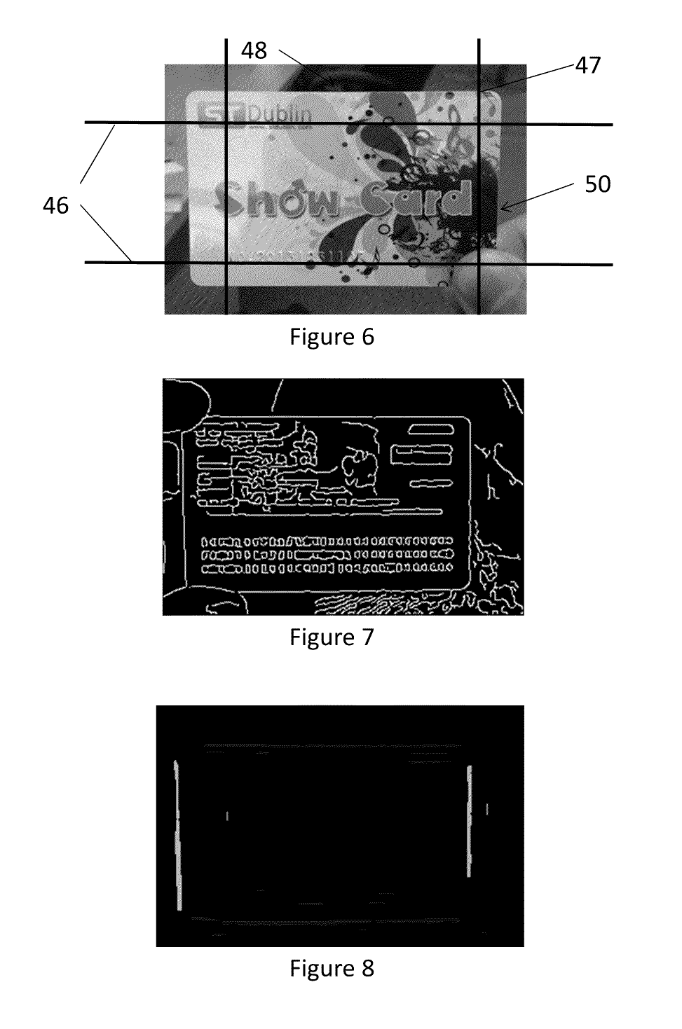

At step 32, the process extracts from the original frame a sub-image that potentially contains the card (as shown in FIG. 6) and optionally downsamples the image to speed up subsequent processing.

The next stage in the process is to detect the edges of the card. One possible way to do this is to use known edge detection algorithms. For example, off-the-shelf edge detection algorithms such as the Canny edge detector and the Sobel edge detector are generalised edge detectors, which not only detect the edges of cards but also noise edges from a cluttered background. However, such algorithms typically detect many unwanted “edges” in addition to the actual card edges as shown in FIG. 7. This is not ideal. For that reason, the invention preferably applies a new edge detection algorithm at step 34 that provides a binary image of the edge segments derived from the downsampled sub-image.

This edge detection algorithm takes into account the nature of the image being analysed (a card) and uses techniques to improve upon more general known algorithms. The preferred edge detection algorithm is defined by steps 1 to 4 below.

The edge detection algorithm operates as follows:

Step 1 provides directional blurring:

Blur the top, bottom, left and right edge areas of the original image using a horizontal kernel

$$[ \begin{matrix}\frac{1}{3} & \frac{1}{3} & \frac{1}{3}\end{matrix} ]$$

for top and bottom edge areas and a vertical kernel

$${[ \begin{matrix}\frac{1}{3} & \frac{1}{3} & \frac{1}{3}\end{matrix} ]}^{T}$$

(transpose or horizontal kernel) on the left and right edge areas. The orientations top, bottom, left and right are with respect to the image and hence with respect to the card being captured since the user is guided to present the card appropriately to the camera, as described in relation to FIG. 4. This operation removes some unwanted noise and intensifies the card edges. The directional blurring may comprise one or more of a variety of processes that operate to reduce the rate of change of an image in a particular direction. Such processes include smoothing or blurring algorithms such as a Gaussian. In the preferred arrangement, the directional blurring operates in one dimension at a time on a line by line basis. The horizontal blurring reduces the rate of change in the horizontal direction and thereby emphasizes the rate of change in the vertical direction (emphasising a horizontal line). Similarly, the vertical blurring reduces the rate of change in the vertical direction (emphasising a vertical line).

Referring against to FIG. 6, the top and bottom card edge areas 48 are above and below boundary lines 46, and the left and right edge areas 50 are outside the vertical boundary lines 47. The boundary lines may be fixed for the system or may be varied according to the dimensions of the card being imaged.

Step 2 uses a directional filter:

A Sobel edge detector is preferably used to operate on the edge areas and outputs derivatives of the gradient changes. From the derivatives produced, the magnitudes and directions of the gradient changes are calculated. Then a fixed threshold is applied on the outputted magnitude to selected pixels of strong gradient changes (usually edges in the image are preserved), further filtering the pixels based on directions of gradient changes. For top and bottom areas, horizontal edges (where gradient changes are nearly vertical) are preserved; for left and right area, vertical edges (where gradient changes are nearly horizontal) are preserved. Finally, a binary image is outputted, which only contains promising edges pixels. The directional filter may be a number of different filters all of which have in common that they produce an output giving magnitude and direction of gradient changes in the image.

The top, bottom, left and right edge areas may be as defined in relation to step 1. By applying thresholds to the gradient changes according to the region of the image, the desired horizontal and vertical lines that are detected as edges are enhanced.

Step 3 Multi-channel processing:

A directional filter such as the Sobel edge detector operates separately on the R, G, and B channels and the final derivatives of gradient changes are aggregated from all channels by taking the maximum value from the outputs of all channels at each pixel location. Multi-channel processing increases the sensitivity of the card detection algorithm, in cases where the environment in which the card image was captured is such that luminance contrast between the card and the background is low but chroma contrast is high. The multi-channel processing may be in any color space, or could be omitted entirely. The choice of R, G, B color space is preferred, but alternatives such as CMYK are also possible. The advantage of processing each channel, then aggregating to take a maximum at each pixel location is that this caters for diverse card and background colors as well as diverse lighting conditions.

Step 4 Directional Morphological Operation:

On the filtered edge image, in the top and bottom edge areas, erode with [1,1,1,1,1,1,1] to remove false edges; in the left and right edge areas, erode with [1,1,1,1,1,1,1]^{T} (transpose of horizontal erosion mask). After erosion, apply dilation with the same masks of erosion in the edge areas. This operation removes some false edges and intensifies card edges. The final image looks like

FIG. 8. The morphological operations improve the output image by removing pixels that appear to be small “edges” (as shown by the edge clutter in FIG. 7). The erosion operation computes a local minimum for the specified kernel, so will reduce visibility of vertical structures in the top and bottom areas and reduce visibility of horizontal structures in the left and right areas. The dilation takes the maximum for the specified kernel and so emphasizes horizontal structures in the top and bottom areas and emphasizes vertical structures in the side areas. In the arrangement described, erosion precedes dilation. The purpose of the erosion step is to remove the remaining false edge segments in the binary image. And after erosion, a dilation operation is used to fill up small gaps between the edge segments and compensates the effect of erosion on the genuine edge segments.

At step 36, the process detects the card edges by using the Probabilistic Hough Transform for line detection on the binary image of edge segments. For each edge line that is detected that matches the specified conditions for a card edge (minimum length of the edge line, angle of the edge line, prediction error of the edge line), the process calculates, at step 38, line metrics (line function and line end points) for the detected edge line. The Hough Transform provides extra information about the lines and in the process by which the edges within the image of FIG. 8 are detected.

If, at step 40, four edge lines are detected in the current frame and 3 or more edge lines were detected in the previous frame, the card is considered to be properly positioned. If, at step 42, the card is also in focus, the application takes a high-resolution image at step 44. Otherwise, the process of steps 32 to 42 is repeated for the next frame.

The arrangement could use the video stream to provide the still image. However, devices tend to use lower resolutions for video streams and so the step of capturing a single still image using the camera functionality of the user device is preferred.

To assist the above process, the client application displays images to the user as follows. For each frame, highlight on the application screen those edges that have been detected, by lighting up the corresponding edges of the displayed frame; turn off such highlighting for edges that failed to be detected. (In FIG. 4, all edges have been detected so all four edges are highlighted).

The user interface by which the user is shown that they have correctly positioned the card within the boundary area is best understood with reference to FIG. 4. The user positions the card in front of the imaging optics of their smart phone or other user device and they can view that card on the screen of the display of their device. A boundary rectangle is shown giving the area within which the card should be positioned. The algorithm described above is operated on the video stream of the card image and, as each of the left, right, top and bottom edges are detected using the technique described above, those edges are indicated by highlighting on the display or changing the color of the edge of the frame so as to indicate to the user that they have correctly positioned the card within the appropriate area.

### Focus Detection Process

We have also appreciated the need for improved focus detection for the purpose of card capture. Clear and sharp images are essential for OCR based applications. However, some user devices cannot provide good focus measurement information. In addition, many devices do not allow applications to control the focus of the device on which they operate, or allow only limited types of control discussed later. A focus detection process has been developed, which uses underlying algorithms for focus metric calculation and focus discrimination.

Focus metrics are calculated values that are highly correlated with the actual focus of the image. Focus discrimination is achieved by applying an adaptive threshold algorithm on the calculated focus metrics.

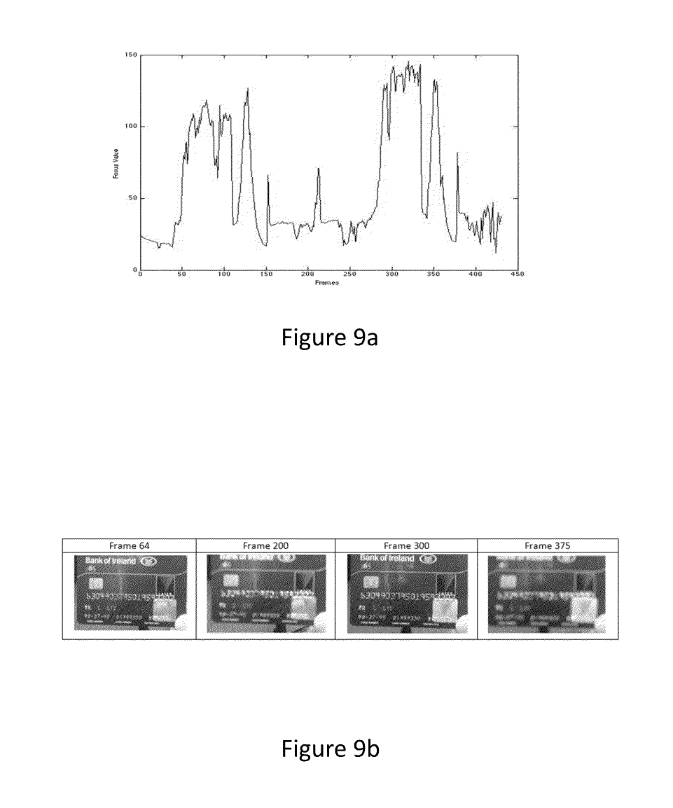

The focus detection aspects of an embodiment of the invention are shown in FIGS. 9a, 9b, 10 and 11. The arrangement determines a focus metric for each frame of a video stream, using one or more algorithms operating on each frame, and then determines whether the current frame is in focus by determining whether the focus metric for that frame is above or below a threshold. The threshold is an adaptive threshold in the sense that it varies adaptively depending upon the focus metric for previous frames. In this way, as the focus metric of each frame in turn is determined, when the focus metric of a given frame is above the adaptive threshold which varies based on the focus metric of previous frames, the system then determines that the focus of the current frame is sufficient. The fact that the focus is sufficient can then be used as part of the triggering of capturing a still image of the card.

The choice of focus metrics used will first be discussed followed by the manner in which the adaptive threshold is determined.

The embodiment uses five distinct focus metric calculation algorithms. Each of these algorithms produces a focus metric value for each sampled frame in a video stream. As shown in FIG. 9a, the higher the focus metric value, the better the actual focus of the image as can be seen intuitively by the example frames of FIG. 9b. Only one focus metric is required for the focus detection algorithm; alternative algorithms may be used depending upon the metric that performs best. The focus metrics that may be used include:
1. Threshold Absolute Gradient:

$$\int {\int }_{image}^{f} \{ \vert \frac{\partial g ( x , y )}{\partial x} \vert - θ \} d x d y$$

2. Squared Gradient:

$$\int {\int }_{image}^{f} {\{ \vert \frac{\partial g ( x , y )}{\partial x} \vert \}}^{2} d x d y$$

3. Squared Laplacian:

$$\int {\int }_{image}^{f} {\{ \vert \frac{{\partial }^{2} g ( x , y )}{{\partial }^{2} ( {x}^{2} )} \vert \}}^{2} d x d y$$

4. Threshold Absolute Sobel Gradient: ∫∫_{image}{|sobel gradient|−θ}dx dy

s, where f(z)=z if z≧0, f(z)=0, otherwise,

$$\vert \frac{\partial g ( x , y )}{\partial x} \vert = \frac{Δ g}{Δ x} = g ( i , j ) - g ( i , j - 1 ) , \vert \frac{{\partial }^{2} g ( x , y )}{{\partial }^{2} ( {x}^{2} )} \vert = g ( i , j + 1 ) - 2 g ( i , j ) + g ( i , j - 1 ) ,$$

|sobel gradient| is calculated by convolving image with kernel

$$[ \begin{matrix}- 1 & 0 & 1 \\ - 2 & 0 & 2 \\ - 1 & 0 & 1\end{matrix} ] ,$$

g is the grayscale image and g(i,j) is the pixel value at the i^{th} row, j^{th} column.

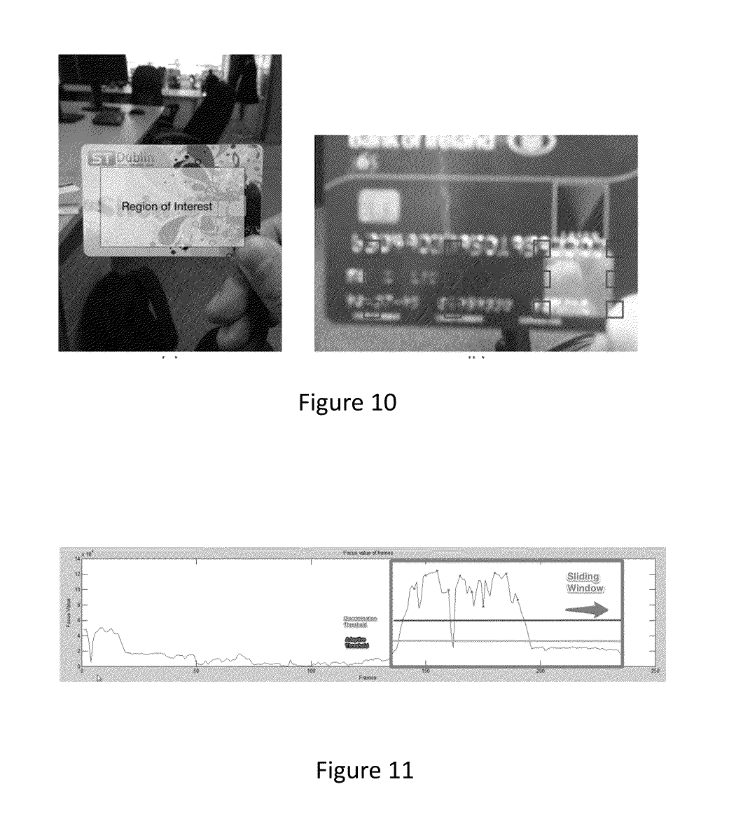

The above focus metrics may be used in an embodiment, but the preferred approach is to use a Discrete Cosine Transform (DCT). As is known to the skilled person, a discrete cosine transform (DCT) expresses a finite sequence of data points in terms of a sum of cosine functions oscillating at different frequencies. In the DCT approach, focus values are calculated block by block (a 4×4 block size is used in the preferred implementation as shown by the sample areas in a region of interest in FIG. 10). A DCT transformation is applied to each image block, producing a representation of the block in the frequency domain. The result contains a number of frequency components. One of these components is the DC component, which represents the baseline of the image frequency. The other components are considered to be high-frequency components. The sum of all the quotients of the high frequency components divided by the DC component is considered to be the focus value of the block. The focus value of the image can be calculated by aggregating the focus values for all blocks.

The process for producing the preferred focus metric may therefore be summarised by the following steps:
1. For each 4×4 pixel block of the image, apply 2D DCT operation and obtain a 4×4 DCT frequency map.
2. For each frequency map, divide the ‘high frequency’ components by the major ‘low frequency’ component (DC component). Sum up all quotients as the result of the block.
3. Sum of the results of all blocks to produce the final focus metric.

The focus metric can be used on sub-images of the original image. Focus values can be calculated in regions of interest of the original image. This feature gives the application the ability to specify the region to focus on, as shown in FIG. 10. By calculating a focus metric for small sub regions of the original image, the CPU consumption is also reduced.

The system must cope with a wide variety of different devices under different lighting conditions and card surfaces. When one of these conditions changes, the focus metrics can output values with significantly different ranges. Using a fixed threshold cannot discriminate focused images for all variations of image capture conditions. In order to provide accurate focus discrimination, an adaptive threshold algorithm has been created which can automatically adjust threshold values according to the focus values of historical sampled frames.

The adaptive threshold algorithm uses the following features:

Sliding window: The algorithm keeps the focus values of recently sampled frames, using focus values within a sliding window, in which focus values are retained for frames within that window. The window moves with the live video stream, thereby retaining the focus values for a specified number of frames. The windows moves concurrently with the video stream, with the newly sampled focus values added in from the right side of the window and old focus values dropped out from the left side of the window, as shown in FIG. 11.

The adaptive algorithm then operates as follows in relation to the sliding window. For each newly sampled frame the focus metric is calculated and the moving sliding window moved. The adaptive threshold is recalculated based on an unfocused base line, a focused base line and a discrimination threshold for the focus values within the sliding window. The focus value for the current frame is then compared to the adaptive threshold and the discrimination threshold and, if the focus value is above the adaptive threshold and discrimination threshold, then the frame is deemed to be in focus. The values used within the focus detection process are as follows:

Minimum window size: This is the minimum number of sampled frames that must be present in the sliding window before the adaptive threshold algorithm is applied.

Maximum window size: This is the maximum number of sampled frames in the sliding window.

Adaptive threshold: This threshold value roughly separates focused frames from non-focused frames. It adapts itself according to the values in the sliding window. If there is no value above the adaptive threshold in the sliding window, the adaptive threshold decreases; if there is no value below the adaptive threshold in the sliding window, the adaptive threshold increases. The adaptive threshold is adjusted whenever a new frame is sampled.

Adaptive threshold higher limit: This is the limit to which the adaptive threshold can grow.

Adaptive threshold lower limit: This is the limit to which the adaptive threshold can shrink.

Adaptive threshold increase speed: This is the speed at which the adaptive threshold increases.

Adaptive threshold decreasing speed: This is the speed at which the adaptive threshold decreases.

Un-focused baseline: This is the mean of focus values lower than the adaptive threshold in the sliding window.

Focused baseline: This is the larger of: the mean of focus values higher than the discrimination threshold in the sliding window; or the current adaptive threshold value.

Discrimination threshold: This threshold is used for discriminating focused frames from unfocused frames. This threshold is the largest value among: the adaptive threshold, double the un-focused baseline and 80% of the focus baseline. These numbers may change after parameter optimisation.

Using the combination of determining a focus metric for each frame and varying the adaptive threshold for that focus metric based on the focus metric for a certain number of previous frames as defined by the sliding window, an accurate determination of the focus of an image may be made within the user device. This is achieved by analysing the video frames themselves, and without requiring control over the imaging optics of the device. An advantage of this is that the technique may be used across many different types of device using a process within a downloadable application and without direct control of the imaging optics (which is not available to applications for many user devices).

As a further addition, some control of the imaging optics may be included. For example, some devices allow a focus request to be transmitted from a downloadable application to the imaging optics of the device, prompting the imaging optics to attempt to obtain focus by varying the lens focus. Although the device will do its best to focus on the object, it is not guaranteed to get a perfectly focused image using this autofocus function. The imaging optics will then attempt to hunt for the correct focus position and, in doing so, the focus metric will vary for a period of time. The process described above is then operable to determine when an appropriate focus has been achieved based on the variation of the focus metric during the period of time that the imaging optics hunts for the correct focus.

### Card Framing Process

We have also appreciated the need, once a high resolution image has been acquired, for the card detection process to be re-run to accurately locate the position of the card and produce a perspectively correct image of the card surface. Once this is done the output is a properly framed card image.

We have appreciated, though, that there are challenges: For example, in cases where the user's fingers occlude the corners of card, simple pattern matching techniques may fail to locate the correct location of corners. A properly framed card in the sense that no additional background is included, no parts are missing and the perspective is correct assists any subsequent process such as OCR.

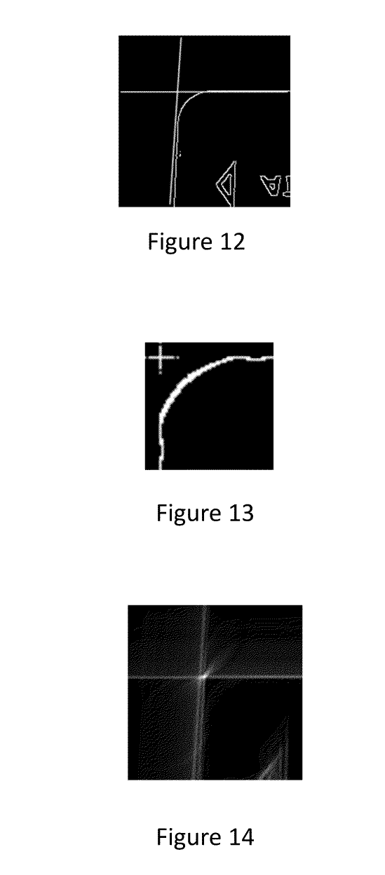

The broad steps of the card framing process in an embodiment are as follows, and as shown in FIGS. 12 to 15.

First, rerun the card detection process to obtain candidate edge lines for the high-resolution image. The card detection process is re-run only if needed, for example if the final image being processed is freshly captured still image. If the image being used is, in fact, one of the frames of the video stream analysed, the card edges may already be available from the earlier card detection process. If the algorithm fails to detect any of the four edge lines, use the line metrics produced by the Card Detection Process as the edge line metrics for the high-resolution image.

If a high resolution still image is used, the next step is to extract the card region from the high-resolution image and resize it to 1200×752 pixels. At this stage, the arrangement has produced a high resolution image of just the card, but the perspective may still require some correction if the card was not held perfectly parallel to the imaging season of the client device. For this reason a process is operated to identify the “corners” of the rectangular shape and then to apply perspective correction such that the corners are truly rectangular in position.

To identify the corners, the next step is to extract the corner regions (for example 195×195 patches from the 1200×752 card region).

For simplicity of processing, the process then “folds” the corner regions so that all the corners point to the northwest and thus can be treated the same way. The folding process is known to the skilled person and involves translating and/or rotating the images.

The next step is to split each corner region into channels. For each channel, the process produces an edge image (for example using a Gaussian filter and Canny Edge Detector). The separate processing of each channel is preferred, as this improves the quality, but a single channel could be used.

Then, the process step is to merge the edge images from all channels (for example using a max operator). This produces a single edge image that results from the combined edge image of each channel.

The edge image processing steps so far produce an edge image of each corner as shown in FIG. 12. The process next identifies the exact corner points of the rectangular image.

To do this, the process draws the corresponding candidate edge line (produced in the first step) on each corner edge image, as shown in FIG. 12. Then a template matching method is used to find the potential corner coordinates on the corner edge image. Template matching techniques are known to the skilled person and involve comparing a template image to an image by sliding one with respect to the other. A template as shown in FIG. 13 is used for this process. The result matrix of the template matching method is shown in FIG. 14. The brightest locations indicate the highest matches. In the result matrix, the brightest location is taken as the potential edge corner. The corners are then unfolded to obtain corner coordinates.

The process then perspectively corrects the card region specified by the corner coordinates and generates the final card image (this can either be a color image or a grayscale image). An example is shown in FIG. 15.

When complete, the device transmits the properly framed card image to the server.

### Image Upload

The properly framed card image produced by the card framing process is immediately uploaded to the back-end OCR service for processing. Before uploading, the card image is resized to a size suitable for transmission (1200×752 is used in the current application). The application can upload grayscale or color images. The final image uses JPEG compression and the degree of compression can be specified.

In addition to the processed image that is uploaded immediately, the original high resolution image captured is uploaded to a remote server or Cloud storage for further processing, such as a fraud detection or face recognition based ID verification.

As the size of a high-resolution image can reach 10 to 20 MB, serializing it to the file system and uploading it to remote storage takes a long time. In order to minimise the impact on the user experience and the memory consumption of the client while uploading, a queue-based background image upload method (as shown in FIG. 16) has been developed.

The arrangement has the following features:

Image serialization queue: This is a first-in-first-out (FIFO) queue maintaining the images to be serialised to the file system.

Image upload queue: This is a FIFO queue maintaining the path information of image files to be uploaded to remote storage.

Serialization background thread: This serialises the images in the image serialization queue from memory to the file system in the background.

Upload background thread: This uploads the images referenced by the path information in the image upload queue from the client's file system to a remote server or Cloud storage in the background.

Background upload process:

After an image has been captured, the image is stored in memory on the client. The captured images are put in an image serialization queue. The images in the queue are serialised to the client's file system one by one by the serialization background thread. After serialization, the image is removed from the image serialization queue and the storage path information of the image file (not the image file itself) is put in a file upload queue. The upload background thread uploads the images referenced by the storage path information in the image upload queue one by one to remote storage. Once an image has been uploaded successfully, it is removed from the file storage and its storage path information is also removed from the image upload queue. The image upload queue is also backed up on the file system, so the client can resume the image upload task if the client is restarted.

1. A method operable on a user device which includes a camera and which is in communication with a computer system, the method comprising:
using the user device to apply for an online loan;
using the camera of the user device to capture an image of a document in the possession of the user and transmitting the image to the computer system for use as part of an automated decision making process to determine whether to provide an online loan to the user; and
receiving the result of the automated decision making process from the computer system.

2. The method of claim 1, wherein the document is one of an identification card or a credit card.

3. The method according to claim 1, further comprising the user device providing an indication to the user that the document is correctly positioned relative to the camera.

4. The method of claim 1, further comprising:
the camera capturing a stream of frames, each frame being a respective image of the document;
the user device:
processing a plurality of the captured frames to produce an edge image for each processed frame, the edge image for each respective processed frame emphasizing horizontal structures at top and bottom areas and vertical structures at left and right areas of the respective processed frame;
using an edge detection algorithm on each edge image to determine whether one or more edges of the document have been located; and
automatically capturing the image of the document in response to the edge detection algorithm determining that edges of the document have been located.

5. The method of claim 4, wherein the processing of each respective frame comprises horizontally blurring top and bottom areas and vertically blurring left and right areas of the respective frame.

6. The method of claim 4, wherein processing each respective frame includes processing different resolutions of the respective frame.

7. The method of claim 4, wherein processing each respective frame comprises operating a directional filter on top, bottom, left and right areas of the respective frame.

8. A method of claim 7, wherein the directional filter produces derivatives of gradient changes.

9. The method of claim 7, wherein the directional filter is a Sobel edge filter.

10. The method of claim 7, wherein the directional filter is a Hough Transform.

11. The method of claim 7, wherein processing each respective frame further comprises operating the directional filter on each of multiple color channels of the respective frame.

12. The method of claim 11, wherein the color channels are RGB.

13. The method of claim 11, wherein the processing of each respective frame takes the maximum value of each channel for each pixel of the respective frame.

14. The method of claim 4, further comprising operating morphological operations on the results of the directional filter.

15. The method of claim 14, wherein the morphological operations include one of more of eroding and dilation applied to the top, bottom, left and right areas.

16. The method of claim 4, wherein the video stream comprises an immediate succession of frames taken by the camera.

17. The method of claim 4, further comprising providing a visual indication on a display of the user device when one or more edges have been located.

18. The method of claim 4, wherein the document is an identification card or a credit card and the step of automatically capturing a image occurs in response to all four edges of the identification card or credit card being detected.

19. A method of claim 1, further comprising:
the camera capturing a stream of frames, each frame being a respective image of the document;
the user device:
processing a plurality of the captured frames to produce respective focus metric for each processed frame, the focus metric for each processed frame being indicative of the focus of the respective frame;
establishing an adaptive threshold of the focus metric;
varying the adaptive threshold based on a history of variation of the focus metric over a plurality of the processed frames;
determining whether the focus metric of a current frame is above the adaptive threshold; and
automatically capturing the image of the document in response to determining the focus metric of the current frame to be above the adaptive threshold.

20. The method of claim 19, wherein the adaptive threshold decreases if the focus metric of a plurality of successive processed frames remains below the adaptive threshold.

21. A method of claim 19, wherein the adaptive threshold decreases at a predetermined rate of decrease.

22. The method of claim 19, wherein the adaptive threshold increases if the focus metric of successive processed frames remains above the adaptive threshold.

23. The method of claim 19, wherein the adaptive threshold increases at a predetermined rate of increase.

24. The method of claim 19, wherein the adaptive threshold is limited in range by an upper limit and a lower limit.

25. The method of claim 19, wherein the image is automatically captured only when the focus metric of the current frame is above both the adaptive threshold and a further threshold.

26. The method of claim 25, wherein the further threshold is a function of those mean of focus values which are lower than the adaptive threshold for the processed frames.

27. The method of claim 26, wherein the function is a multiple of the mean of focus values which are lower than the adaptive threshold for the processed frames.

28. The method of claim 25, wherein the further threshold is a function of those mean of focus values which are higher than the adaptive threshold for the processed frames.

29. The method of claim 26, wherein the function is a multiple of the mean of focus values which are higher than the adaptive threshold for the processed frames.

30. The method of claim 19, wherein the document is a credit card or an identification card.

31. The method of claim 19, wherein the method is operable without control of focus of the device.

32. The method of claim 1, further comprising:
the camera capturing a stream of frames, each frame being a respective image of the document;
the user device:
processing a plurality of the captured frames using an edge detector to obtain candidate edges;
processing the frame to produce an edge image;
obtaining corner points at the intersection candidate edges; and
processing the frame to correct perspective such that the corner points of the image are at corners of a rectangle.

33. The method of claim 32, wherein the step of producing an edge image comprises producing an edge image in each of multiple channels and combining the edge images.

34. The method of claim 33, wherein the combining comprises taking the maximum value at each pixel from each of the edge images.

35. The method of claim 32, wherein obtaining corner points uses a template process with a template of a known corner and corner point position.

36. The method of claim 32, further comprising folding corners prior to processing.

37. A non-transitory computer readable medium having a computer program stored therein, the program, when executed on one or more processors of a computerized user device, causes the user device to:
apply for an online loan;
use a camera of the user device to capture an image of a document in the possession of the user; and transmit the image to an online loan application system as part of the online loan application; and
receive, from the outline loan application system, the result of an automated decisioning process in which a determination is made whether to provide an online loan to the user.

38. A plug-in for a computer system comprising one or more processors, a display, one or more user devices allowing a user to input commands into the computer system, the one or more user devices including a camera, the plug-in comprising instructions which when executed on a user device cause the device to:
apply for an online loan;
capture an image of a document in the possession of the user, and transmit the image to an online loan application system as part of the online loan application; and
receive, from the outline loan application system, the result of an automated decisioning process in which a determination is made whether to provide an online loan to the user.

39. A central computer system comprising one or more processors, one or more memories and one or more programs stored in one or more memories for execution by one or more of the processors, causing the system to:
receive an application for an online loan from a user device;
receive an image of a document captured by a camera of the user device as part of the online loan application; and
use the image of the document as part of a decisioning process in which a determination is made whether to provide an online loan to the user.
